(19) United States
(12) Patent Application Publication
(10) Pub. No.: US 2019/0192892 A1
(43) Pub. Date: Jun. 27, 2019

(54) Inert Gas Remote Driver Liquid Fire Suppression Systems

(71) Applicant: Carrier Corporation, Palm Beach Gardens, FL (US)

(72) Inventor: Paul M. Johnson, Clinton, MA (US)

(73) Assignee: Carrier Corporation, Palm Beach Gardens, FL (US)

(21) Appl. No.: 16/199,597

(22) Filed: Nov. 26, 2018

Related U.S. Application Data
(60) Provisional application No. 62/610,032, filed on Dec. 22, 2017.

(51) Int. Cl. A62D 1/00; A62C 35/02; A62C 35/13; A62C 37/44; A62C 99/00

(52) U.S. Cl. CPC A62D 1/0092; A62C 35/023; A62C 99/0018; A62C 37/44; A62C 35/13

(57) ABSTRACT

A fire suppression system (20) has a gas source (22) and at least one vessel (60) containing a liquid suppressant (62). A respective flowpath extends from each said vessel to one or more associated first outlets (73). A respective propellant flowpath extends from the gas source to each said vessel and is coupled to a headspace (70) of the vessel. At least one first pressure reducing device (30) and at least one second pressure reducing device (44) are in series along the propellant flowpath between the gas source and the at least one vessel.

### CROSS-REFERENCE TO RELATED APPLICATION

Benefit is claimed of U.S. Patent Application No. 62/610,032, filed Dec. 22, 2017, and entitled “Inert Gas Remote Driver Liquid Fire Suppression Systems”, the disclosure of which is incorporated by reference herein in its entirety as if set forth at length.

### BACKGROUND

The disclosure relates to fire suppression. More particularly, the disclosure relates to systems using liquid agents.

Hydroflourocarbon (HFC) agents have been used for decades. Halon 1301 (bromotrifluoromethane) is a key such HFC. These are in disfavor due to environmental concerns.

Among recent replacements for HFC agents, 3M™ Novec™ 1230 fire protection fluid (3M, St. Paul, Minn.) is a fluoroketone named dodecafluoro-2-methylpentan-3-one (CF₃CF₂C(O)CF(CF₃)₂). Its ASHRAE nomenclature is FK-5-1-12. In the Kidde™ ADS™ fire suppression system (Kidde-Fenwal, Inc., Ashland, Mass.), this agent is used with an N₂ propellant. Normally stored as a liquid, the low heat of evaporation and high vapor pressure (e.g., relative to water) means that the agent will rapidly vaporize at discharge from the nozzle outlets and be delivered as vapor.

An increasing number of applications for fire suppression suffer from use of chemical suppressants. For such applications, essentially inert gaseous suppressants are used. These include argon, nitrogen, and their mixtures. Commercially available argon-nitrogen suppressants include a 50-50 by weight N₂/Ar mixture and a 52-40-8 by weight N₂/Ar/CO₂ mixture. These are typically stored at a pressure of about 200 bar to 300 bar (e.g. at typical room temperatures such as an exemplary reference temperature of 15° C. or 21° C.). A particularly significant application for inert suppressants is automatic fire extinguishing systems for server rooms, data centers, and the like.

### SUMMARY

One aspect of the disclosure involves a fire suppression system comprising: a gas source and at least one vessel containing a liquid suppressant. A respective flowpath extends from each said vessel to one or more associated first outlets. A respective propellant flowpath extends from the gas source to each said vessel and is coupled to a headspace of the vessel. At least one first pressure reducing device and at least one second pressure reducing device are in series along the propellant flowpath between the gas source and the at least one vessel.

In one or more embodiments of any of the foregoing embodiments, the at least one first pressure reducing device comprises a plurality of first pressure reducing devices not in series.

In one or more embodiments of any of the foregoing embodiments, the at least one vessel is a plurality of vessels and the at least one second pressure reducing device is a plurality of second pressure reducing devices respectively in series with an associated vessel of the plurality of vessels.

In one or more embodiments of any of the foregoing embodiments, the gas source is at a pressure of at least 100 bar.

In one or more embodiments of any of the foregoing embodiments, the gas source is at a pressure of 100 bar to 300 bar.

In one or more embodiments of any of the foregoing embodiments, the gas comprises at least 70% by weight argon, nitrogen, or combined argon and nitrogen.

In one or more embodiments of any of the foregoing embodiments, other than said argon and/or said nitrogen and other noble gases and carbon dioxide, if any, the gas comprises no more than 5% by weight all other constituents total.

In one or more embodiments of any of the foregoing embodiments, the gas comprises at least 30% each of nitrogen and argon by weight.

In one or more embodiments of any of the foregoing embodiments, the gas source comprises a plurality of cylinders in parallel.

In one or more embodiments of any of the foregoing embodiments, a controller is configured to independently control flow from the respective cylinders.

In one or more embodiments of any of the foregoing embodiments, the fire suppression system of claim 1 further comprises a plurality of second outlets and respective flowpaths from the gas source to the second outlets not passing through any liquid suppressant body.

In one or more embodiments of any of the foregoing embodiments, a method for using the fire suppression system comprises for one or more of the at least one vessel: opening a valve to pass the gas along the propellant flowpath to pressurize the headspace and propel the liquid suppressant along the flowpath from the vessel to the one or more associated first outlets.

In one or more embodiments of any of the foregoing embodiments, the opening of the valve leaves closed other valves so as to not discharge suppressant from one or more others of the at least one vessel.

In one or more embodiments of any of the foregoing embodiments, in addition to the opening of the valve, the method includes opening another valve to directly discharge the gas via one or more second outlets.

In one or more embodiments of any of the foregoing embodiments, the gas comprises at least 70% by weight argon, nitrogen, or combined argon and nitrogen.

Another aspect of the disclosure involves a fire suppression system comprising a gas source and at least one vessel containing a liquid suppressant. A respective first flowpath extends from the gas source through each said vessel to one or more first outlets. A respective second flowpath extends from the gas source to one or more second outlets. At least one first pressure reducing device and at least one second pressure reducing device are in series along the first flowpath between the gas source and the at least one vessel. The second flowpath does not pass through a vessel containing liquid suppressant.

In one or more embodiments of any of the foregoing embodiments, the gas source is at a pressure of 100 bar to 300 bar.

In one or more embodiments of any of the foregoing embodiments, the gas comprises at least 70% by weight argon, nitrogen, or combined argon and nitrogen.

In one or more embodiments of any of the foregoing embodiments, the gas comprises at least 30% each of nitrogen and argon by weight.

In one or more embodiments of any of the foregoing embodiments, along each first flowpath there may be a respective burst disk between each said vessel and the associated one or more first outlets.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic view of a fire suppression system.

FIG. 2 is a schematic view of a first endpoint of the system.

FIG. 3 is a schematic view of a second endpoint of the system.

Like reference numbers and designations in the various drawings indicate like elements.

### DETAILED DESCRIPTION

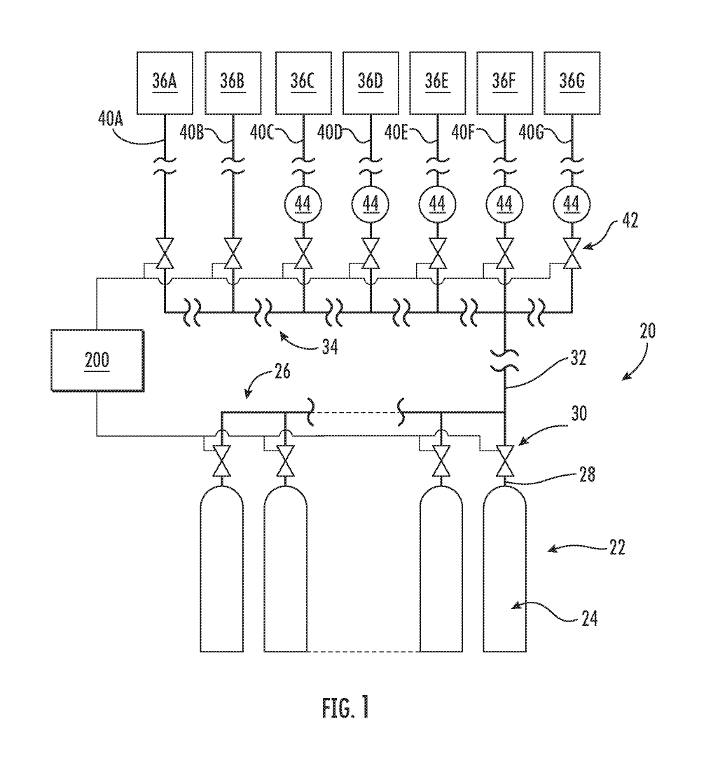

FIG. 1 shows a fire suppression system 20 having an inert gas (e.g., argon and/or nitrogen-based) source 22. An exemplary inert gas source comprises a plurality of inert gas cylinders 24. These are typically stored at a pressure of about 200 bar to 300 bar (e.g. at typical room temperatures such as an exemplary reference temperature of 15° C. or 21° C.), more broadly 100 bar to 300 bar or 150 bar to 300 bar. These may be gage or absolute pressures. Subsequent pressures downstream discussed below are gage pressures.

The exemplary cylinders are coupled in parallel via a supply manifold 26. Each exemplary cylinder has an outlet 28 (e.g., threaded fitting). For each cylinder, one or more control valves and/or controllable pressure regulators (individually or combined in function and hereafter “devices”) 30 may intervene between the outlet 28 and a corresponding port on the supply manifold 26. The devices 30 may be controlled by a controller 200. Exemplary pressure regulation by the devices 30 is to about 70 bar, more broadly 50 bar to 75 bar. This allows use of lower pressure capability ANSI Schedule 40 plastic piping/fittings downstream.

The exemplary supply manifold 26 has an outlet port connected to a main feed line 32 which, in turn, connects to the inlet port of a distribution manifold 34. The distribution manifold 34 has outlets ultimately feeding individual end points shown as 36A-G (collectively or individually 36). As is discussed further below, the end points may have one or more of several different configurations. These different configurations may occur in different installed systems or may coexist at different locations (e.g., rooms or locations within rooms) in a given system installation. Each end point 36 is at the end of a respective delivery line 40A-G (collectively or individually 40). As is discussed further below, the end points themselves may represent single or multiple outlets.

Each of the exemplary lines 40A-G contains a selector valve 42. The selector valves 42 may be connected to and controlled by the controller 200 as are the devices 30. Exemplary selector valves are simple on-off valves such as solenoid valves. Exemplary solenoid valves are electro-pneumatic solenoid valves such as the Type 400 valve of Müller Gas Equipment A/S, Vollerup, Denmark. Depending upon the nature of the end points 36, the associated lines 40 may have pressure regulating devices 44. Exemplary devices 44 may range from simple fixed orifices, to manually adjustable pressure regulators (e.g., shutter-style pressure gages—the manual adjustment may be made in the factory manufacturing the fire suppression system and, in the factory, locked in for safety), to controllable pressure regulators controlled by the controller 200. The orifice size of fixed orifice, or the adjusted or controlled restriction or pressure (of an adjustable or controllable device, respectively), may be tailored to the particular type and size of end point 36. In general, the devices 44 may be effective to limit downstream pressure to a value in the vicinity of 10 bar to 45 bar. This may represent a delta across the device 44 of at least 5 bar or at least 10 bar. The particular regulated pressure will depend on the nature of the agent to be dispensed (discussed below).

Flowpaths from the vessel(s) to the endpoints (or outlets thereof discussed below) allow for controlled discharge of suppressant. The various flowpaths may thus partially overlap with each other. Multiple valves, pressure regulators, and the like may be located along said flowpaths at various places in the system to allow an appropriate amount of suppressant to be delivered to the appropriate nozzles while potentially not discharging from other nozzles. The system may further include sensors (not shown—e.g., heat, smoke, and the like), and switches or other interfaces (not shown) to allow a commanded discharge. The term “flowpath” may apply to an overall flowpath from a gas cylinder to an outlet or to one or more segments of such overall flowpath.

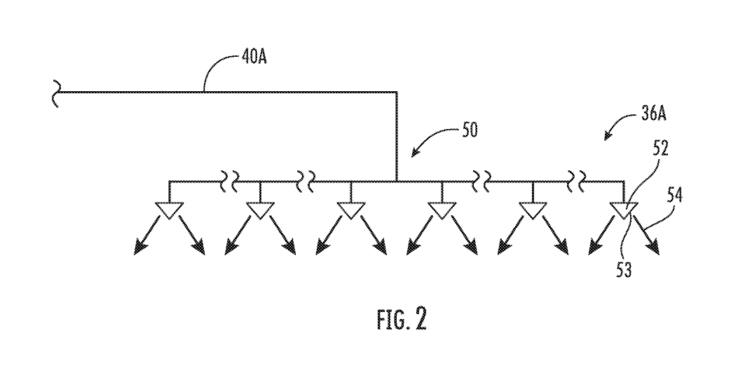

Some of the end points (e.g., 36A and 36B in FIG. 1) may merely discharge the inert gas as a suppressant rather than as a propellant for another agent. FIG. 2 discloses one example of such an end point wherein a discharge manifold 50 has an inlet at the end of line 40A and a plurality of outlets feeding respective nozzles 52. The nozzles 52, in turn, have outlets 53 discharging inert gas flows 54. Examples of locations protected by inert gas only are computer server rooms, computer server room subfloors, ship engine rooms, control rooms, museum display cases, and museum gallery rooms (to protect paintings and other artwork) and other locations typically protected by halocarbons. In such situations, the distribution manifold pressure may be essentially (subject to piping losses) passed to the nozzle outlets.

Other end points may involve additional suppressants or agents whose flow is driven (propelled) by the inert gas from the source 22.

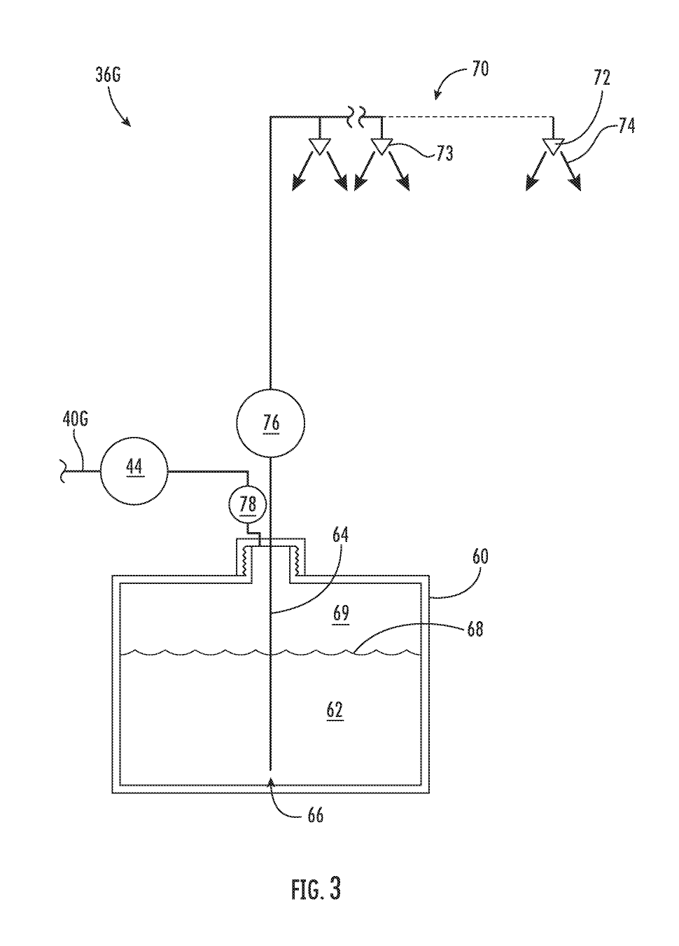

For example, FIG. 3 shows an exemplary end point 36G having a vessel 60 containing a body of liquid agent 62. A discharge conduit 64 has an inlet 66 immersed well below a surface 68 of the liquid 62. The vessel has a headspace (ullage space) 69 which may be pressurized via the line 40G to, in turn, drive/propel the agent into the inlet 66 and through the conduit 64 to a distribution manifold 70 and therefrom as discharge flows 74 from outlets 73 of nozzles 72. The flowpath through said vessel 60 may be considered as having a propellant flowpath or leg extending to the vessel and a discharge flowpath or leg extending from the vessel. In contrast, the gas flowpaths for the endpoints 36A and 36B are only gas flowpaths and do not pass through any vessel containing or formerly containing liquid agent.

A burst disk or other device 76 may be locally along the line 64. Depending on the nature of the agent, it may be stored at zero gauge pressure or at a slight positive gauge pressure (e.g., up to about 5.5 bar (e.g., about 5 bar for HFC 227, about 0.7 bar for Novec™ halocarbon, or close to zero for aqueous agents).

The disk 76 ruptures at a first pressure above the storage pressure of the liquid 62 in the vessel 60 (e.g., by at least 0.5 bar above agent vapor pressure or an exemplary 0.5 bar to 10 bar or an exemplary 6 bar to 8 bar). Thus, when the associated valve 42 (shown in FIG. 1) is opened (and pressure is being supplied by one or more open devices 30), the inert gas fills the headspace 69 pressurizing the vessel 60 until the threshold of the burst disk 76 is overcome. Upon overcoming the burst disk threshold pressure the inert gas drives/propels the agent 62 out through the burst disk and outlets 73 of nozzle(s) 72.

FIG. 3 also shows an upstream burst disk 78 at the gas inlet to the vessel 60. This disk 78 may be positioned to seal the line 40 upstream. This may avoid contamination of the line by vapor from the vessel 60, and may generally have a similar rupture pressure (threshold) to the disk 76. Alternatively, 78 may represent a check valve such as a pilot check valve. As noted above, the device 44 may be configured to provide desired operating pressure for such an end point. Exemplary such pressure is discussed above and further below. Exemplary agent 62 and exemplary use situations are discussed below.

By keeping the storage and use pressure in the vessel 60 relatively low, it need not be configured as a high pressure vessel (e.g., a pressure cylinder). Rather, greater flexibility in packaging may be had to fit a desired amount of agent in a given available space. For example, an engine compartment for an air handler system, which has open space but of 15 liters but could not accommodate a standard 15-liter steel cylinder. Custom vessels may be made of steel, aluminum or composites (e.g., carbon fiber or glass fiber).

For a given type of end point, there may be different sizes. For example, a kitchen system will be sized to the stove type and size and expected type of fire (e.g., gas grills vs. fryers typically present different fire hazards). Likewise a subfloor that uses halocarbon could be of narrow height but wide area, for example, a shallow 1-foot (30 cm) tall but large 30 foot by 30 foot (9 m by 9 m) area, and would need agent storage sized accordingly (e.g., about 240 liters at 300 bar). This would scale with room size.

An exemplary kitchen system (endpoint) uses a water-based agent. An exemplary agent is AquaGreen XT™ aqueous agent (Kidde-Fenwal, Inc., Ashland, Mass.). Exemplary aqueous agents are 40% to 70% by weight water, and the remainder mainly inorganic salts plus chelating agents, typically with only impurity levels of any other components. These will operate at relatively low pressure (e.g., 10 bar to 14 bar, more narrowly, 12 bar to 14 bar, provided by the pressure regulator 44). They remain liquid when discharged.

Another such end point is one with high value equipment (e.g., computer server rooms, data centers, engine rooms, and mechanical control rooms) where aqueous agents risk damaging equipment. Exemplary non-aqueous agents are Novec™ or other halocarbons. Exemplary pressures are 25 bar to 35 bar, more broadly 25 bar to 65 bar or 25 bar to 60 bar provided by the regulator 44. Typically due to the need to vaporize and disperse the vapor, pressures will be higher than the pressure used for aqueous agent.

Yet further end points may be configured to discharge mixtures of the inert gas and some other material. For example, halocarbon agents used in configurations such as FIG. 3 will tend to absorb some of the propellant so that a mixture is discharged. Other situations may involve specifically configuring the end point so that a flow of the propellant entrains liquid or solid agent.

The controller may be configured to stop flow to an end point when the agent is expended and or the occurrence of another condition. The expending may be determined by programming (the controller knows how long flow could be maintained for the available agent) or by a sensor (e.g., a liquid level sensor in the vessel). The other condition may be a sensed room condition such as temperature dropping to a threshold level.

In sustained inerting situations, the system may be configured to discharge inert gas after all agent 62 is expended. Thus, the gas may transition from being merely or principally a propellant (for agent 62) in a first stage of operation from a given end point to being the suppressant/agent in a subsequent stage of operation at that end point. See, PCT/US2017/067641, (the WO '641 application), of Carrier Corporation, filed Dec. 20, 2017, and entitled “FIRE PROTECTION SYSTEM FOR AN ENCLOSURE AND METHOD OF FIRE PROTECTION FOR AN ENCLOSURE”, the disclosure of which is incorporated by reference herein in its entirety as if set forth at length. In such a situation, the gas from the present source 22 would serve as the “inert agent” of the WO '641 application and the present liquid agent 62 would serve as the “primary agent” of the WO '641 application. Similar operational parameters, sensors and control algorithms to those of the WO '641 application could thus be used.

Multiple valves, pressure regulators, and the like may be located at various places in the system to allow an appropriate amount of suppressant to be delivered to the appropriate nozzles while potentially not discharging from other nozzles. The system may further include sensors (not shown—e.g., heat, smoke, and the like), and switches or other interfaces (not shown) to allow a commanded discharge.

As noted above, exemplary inert propellants are argon and/or nitrogen-based. For example, the propellant may comprise at least 70% (or at least 80% or at least 85%) by weight argon, nitrogen, or combined argon and nitrogen. Exemplary argon-nitrogen blends may include at least thirty weight percent each of argon and nitrogen. Nevertheless, more uneven blends are possible. Carbon dioxide is one additional component that may be present in more than trivial levels. Thus, for example, beyond argon and/or said nitrogen and other noble gases and carbon dioxide, if any, the propellant may comprise no more than 5% (or no more than 2%) by weight all other constituents total and/or no more than 2% (or no more than 1%) such other constituents individually.

FIG. 1 further shows a controller 200. The controller may receive user inputs from an input device (e.g., switches, keyboard, or the like) and sensors (not shown, e.g., smoke and/or temperature sensors at various building locations and condition sensors at various locations in the system (e.g., gas pressure sensors)). The controller may be coupled to the sensors and controllable system components (e.g., valves and the like—not shown) via control lines (e.g., hardwired or wireless communication paths 202). The controller may include one or more: processors; memory (e.g., for storing program information for execution by the processor to perform the operational methods and for storing data used or generated by the program(s)); and hardware interface devices (e.g., ports) for interfacing with input/output devices and controllable system components.

The system and its components may be made using otherwise conventional or yet-developed materials and techniques. Operation may also reflect existing techniques, particularly when viewed at the level of the operation of a given end point. Overall operation may comprehend the controller being programmed to selectively open an appropriate combination of the devices 30 to provide a required propellant flow. For example, responsive to sensed fire, heat, smoke, or the like, and/or responsive to manual triggering, the controller 200 may be programmed/configured to engage/discharge a given combination of the end points 36 by opening their respective valves 42. The controller may calculate required gas flow for that combination (e.g., based upon a stored table or database of flow values for each end point). The controller may open an appropriate number of devices 30 to provide this simultaneously with commanding opening the valve(s) 42. In an exemplary situation with electro-pneumatic selector valves 42, actual opening of the valve 42 to pass flow is slightly delayed because it is driven by the pressure introduced upstream via the devices 30.

Depending upon the implementation, various real-time modification of the propellant flows via the devices 30 may be made. For example, in some implementations, flow from one cylinder might be effective to run the necessary end points for only a portion of a period of time (e.g., not all agent will have been expended). In response to a sensed pressure drop or calculated expenditure, the controller may subsequently open a further one or more cylinders to maintain required flow.

Similar adjustments may be made in the case of failures or leaks. These failures or leaks may occur either during discharge or before. In one example of failure before discharge, a pressure sensor on one cylinder may indicate a leak (e.g., lower than specified initial pressure). In such a situation, the controller could be programmed to open others of the cylinders 24 in preference to that leaking cylinder. An example of in-use failure involves a failure of a device 30 to open or perhaps some blockage occurring. Such a failure may be specifically detected (e.g., by pressure sensors indicating pressure in the cylinder is not dropping as it should or possibly from flow sensors indicating a lack of flow). Alternatively, such failure could be inferred by a more generalized sensor determining insufficiency of flow. In either event, one or more additional cylinders may be brought online and, optionally, the initial group of cylinders may be taken off line. For any such leak or failure, the controller may maintain a log for display or downloading to/by a user.

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic system, details of such configuration or its associated use may influence details of particular implementations. Accordingly, other embodiments are within the scope of the following claims.

What is claimed is:

1. A fire suppression system (20) comprising:
a gas source (22);
at least one vessel (60) containing a liquid suppressant (62);
a respective flowpath from each said vessel to one or more associated first outlets (73);
a respective propellant flowpath from the gas source to each said vessel and coupled to a headspace (69) of the vessel; and
at least one first pressure reducing device (30) and at least one second pressure reducing device (44) in series along the propellant flowpath between the gas source and the at least one vessel.

2. The fire suppression system of claim 1 wherein:
the at least one first pressure reducing device (30) comprises a plurality of first pressure reducing devices not in series.

3. The fire suppression system of claim 1 wherein:
the at least one vessel is a plurality of vessels; and
the at least one second pressure reducing device is a plurality of second pressure reducing devices respectively in series with an associated vessel of the plurality of vessels.

4. The fire suppression system of claim 1 wherein:
the gas source is at a pressure of at least 100 bar.

5. The fire suppression system of claim 1 wherein:
the gas source is at a pressure of 100 bar to 300 bar.

6. The fire suppression system of claim 1 wherein:
the gas comprises at least 70% by weight argon, nitrogen, or combined argon and nitrogen.

7. The fire suppression system of claim 6 wherein:
other than said argon and/or said nitrogen and other noble gases and carbon dioxide, if any, the gas comprises no more than 5% by weight all other constituents total.

8. The fire suppression system of claim 1 wherein:
the gas comprises at least 30% each of nitrogen and argon by weight.

9. The fire suppression system of claim 1 wherein:
the gas source comprises a plurality of cylinders (24) in parallel.

10. The fire suppression system of claim 9 further comprising:
a controller (200) configured to independently control flow from the respective cylinders.

11. The fire suppression system of claim 1 further comprising:
a plurality of second outlets (53); and
respective flowpaths from the gas source to the second outlets not passing through any liquid suppressant body.

12. A method for using the fire suppression system of claim 1, the method comprising for one or more of the at least one vessel:
opening a valve (42) to pass the gas along the propellant flowpath to pressurize the headspace and propel the liquid suppressant along the flowpath from the vessel to the one or more associated first outlets.

13. The method of claim 12 wherein:
the opening of the valve (42) leaves closed other valves so as to not discharge suppressant from one or more others of the at least one vessel.

14. The method of claim 12 wherein:
in addition to the opening of the valve (42), the method includes opening another valve (42) to directly discharge the gas via one or more second outlets (53).

15. The method of claim 12 wherein:
the gas comprises at least 70% by weight argon, nitrogen, or combined argon and nitrogen.

16. A fire suppression system (20) comprising:
a gas source (22);
at least one vessel (60) containing a liquid suppressant (62);
a respective first flowpath from the gas source through each said vessel to one or more first outlets (73);
a respective second flowpath from the gas source to one or more second outlets (53); and
at least one first pressure reducing device (30) and at least one second pressure reducing device (44) in series along the first flowpath between the gas source and the at least one vessel, wherein the second flowpath does not pass through a vessel containing liquid suppressant.

17. The fire suppression system of claim 16 wherein:
the gas source is at a pressure of 100 bar to 300 bar.

18. The fire suppression system of claim 16 wherein:
the gas comprises at least 70% by weight argon, nitrogen, or combined argon and nitrogen.

19. The fire suppression system of claim 16 wherein:
the gas comprises at least 30% each of nitrogen and argon by weight.

20. The fire suppression system of claim 16 further comprising:
along each first flowpath, a respective burst disk (76) between each said vessel and the associated one or more first outlets.
